(19) United States
(12) Patent Application Publication
(10) Pub. No.: US 2004/0217302 A1
(43) Pub. Date: Nov. 4, 2004

(54) Electron beam lithography system

(76) Inventors: Yong Woo Shin, Daejeon-city (KR); Dongyel Kang, Busan-city (KR); Sang Kuk Choi, Daejeon-city (KR); Dae Yong Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/750,004

(22) Filed: Dec. 30, 2003

(30) Foreign Application Priority Data
May 2, 2003 (KR) 2003-28165

(51) Int. Cl. G21G 5/00

(52) U.S. Cl. 250/492.1

(57) ABSTRACT

Provided is a high-speed electron beam lithography system including a transfer chamber; a plurality of electron beam lithography chambers, each of which is connected to the transfer chamber and includes a multicolumn portion; and input and output loadlock chambers, each of which is connected to the transfer chamber. Herein, the plurality of electron beam lithography chambers and the input and output loadlock chambers are connected to the transfer chamber, forming a cluster. Also, a plurality of wafers are respectively loaded into the plurality of electron beam lithography chambers so as to drive the electron beam lithography chambers at the same time.

This application claims the priority of Korean Patent Application No. 2003-28165, filed on May 2, 2003, in the Korean Intellectual Property Office, the contents of which are incorporated herein in their entirety by reference.

### BACKGROUND OF THE INVENTION

1. Field of the Invention

The present invention relates to an electron beam lithography system, and more particularly, to a high-speed electron beam lithography system.

2. Description of the Related Art

Electron beam lithography is the next-generation lithography method that improves the resolution characteristics of conventional optical lithography. A current semiconductor manufacturing process can secure high resolution through this electron beam lithography. However, the electron beam lithography, which should be separately applied to individual wafers, impedes mass production.

Conventionally, to solve low productivity of the electron beam lithography, PCT patent application No. WO 2000/67290 entitled “Integrated Microcolumn and Scanning Probe Microscope Array” was disclosed. This conventional system for processing wafers and probing the surfaces of the wafers (or an electron beam lithography system) comprises a micro-multicolumn and a scanning probe microscope, and the micro-multicolumn enables high-resolution scanning of wafers at high speed.

Although the conventional electron beam lithography system allows a high-speed exposure process due to the micro-multicolumn, the exposure process should be performed on each wafer in a single chamber. As a result, the conventional electron beam lithography system cannot come up to the speed of a typical optical lithography system.

Also, unlike an optical lithography system, the conventional electron beam lithography system must process a single wafer in vacuum. Thus, individual wafers must be loaded into and unloaded from the chamber every time. Also, since it takes much time to create an ultra high vacuum environment of about 10⁻⁷ torr to 10⁻¹⁰ torr, the speed of processing wafers with the electron beam lithography system decreases.

Further, in a single column type electron beam lithography system, a lithography process takes a large amount of exposure time of about 15 hours for a 200-mm wafer. Thus, a time of about 3 to 10 minutes taken to load and unload a wafer does not matter in the single column type electron beam lithography process. However, in conventional micro-multicolumn type electron beam lithography systems, the time taken to load and unload a wafer significantly affects the speed of lithography.

### SUMMARY OF THE INVENTION

In accordance with an aspect of the present invention, there is provided an electron beam lithography system for performing electron beam lithography. The system comprises a transfer chamber; a plurality of electron beam lithography chambers; and input and output loadlock chambers. Each of the electron beam lithography systems is connected to the transfer chamber and includes a multicolumn portion. Each of the input and output loadlock chambers is connected to the transfer chamber. Herein, the plurality of electron beam lithography chambers and the input and output loadlock chambers are connected to the transfer chamber, forming a cluster. Also, a plurality of wafers are respectively loaded into the plurality of electron beam lithography chambers so as to drive the electron beam lithography chambers at the same time.

A pre-baking chamber and a post-baking chamber may be further connected to the transfer chamber. An alignment chamber including an aligner may be connected between the transfer chamber and the input loadlock chamber. A cooling chamber including a cooling plate may be connected between the transfer chamber and the output loadlock chamber. A transfer robot for transferring wafers may be installed in the transfer chamber.

Also, a bottom portion on which the transfer chamber is installed may be spaced a predetermined distance apart from a bottom portion on which each of the lithography chambers is installed, to cut off noise generated by the transfer chamber. Preferably, the bottom portion on which each of the lithography chambers is installed is an anti-vibrator.

A flexible adaptor and a slot valve may be installed between the transfer chamber and each of the lithography chambers. The flexible adaptor may be formed of one of rubber and stainless steel.

The pressure in each of the transfer chamber, the loadlock chamber, the lithography chambers into which wafers are loaded, the pre-baking chamber, and the post-baking chamber may be held in the range from about 10⁻⁶ torr to 10⁻⁷ torr. Also, the pressure in the multicolumn portion in each of the lithography chambers may be held in the range from about 10⁻¹⁰ torr to 10⁻¹¹ torr.

### BRIEF DESCRIPTION OF THE DRAWINGS

The above and other features and advantages of the present invention will become more apparent by describing in detail exemplary embodiments thereof with reference to the attached drawings in which:

FIG. 1 is a plan view of an electron beam lithography system according to the present invention;

FIG. 2 is a sectional view taken along line II-II′ of FIG. 1; and

FIG. 3 is a block diagram illustrating operations of the electron beam lithography system according to the present invention.

### DETAILED DESCRIPTION OF THE INVENTION

The present invention will now be described more fully with reference to the accompanying drawings, in which preferred embodiments of the invention are shown. This invention may, however, be embodied in many different forms and should not be construed as being limited to the embodiments set forth herein. Rather, these embodiments are provided so that this disclosure is thorough and complete and fully conveys the concept of the invention to those skilled in the art. In the drawings, the thicknesses of layers may be exaggerated for clarity, and the same reference numerals are used to denote the same elements throughout the drawings.

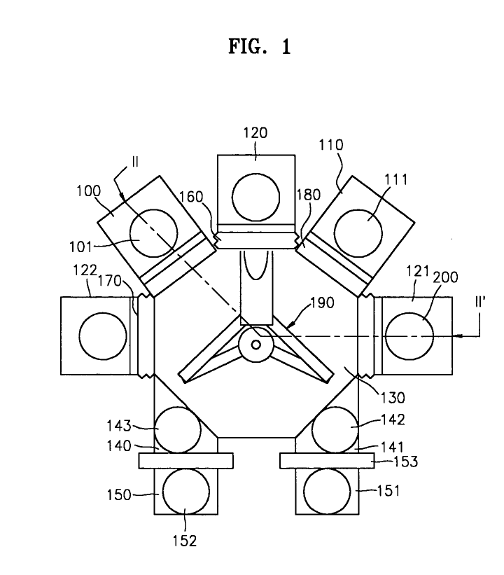

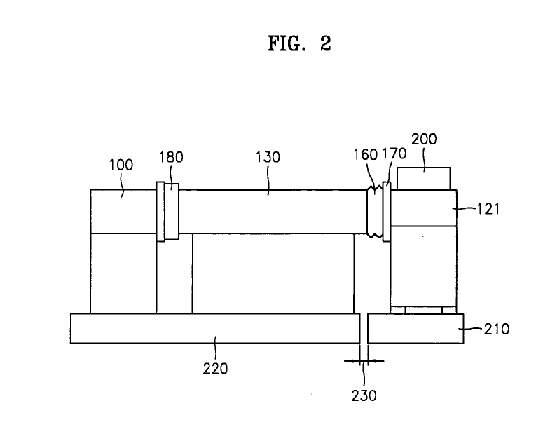

Referring to FIG. 1 in which a plan view of an electron beam lithography system of the present invention is shown, a plurality of chambers are integrated so as to accelerate an electron beam lithography process.

More specifically, the electron beam lithography system comprises baking chambers 100 and 110 for performing a baking process, lithography chambers 120, 121, and 122 for performing an electron beam lithography process, loadlock chambers 150 and 151 in which wafers stand by for processes, and a transfer chamber 130 installed in the center of the system that is connected to each of the chambers 100, 110, 120, 121, 122, 150, and 151.

Here, the transfer chamber 130 refers to a path through which a wafer is transferred, and the other chambers 100, 110, 120, 121, 122, 150, and 151 may be radially disposed around the transfer chamber 130. The pressure in the transfer chamber 130 may be held in the range from about 10⁻⁶ torr to 10⁻⁷ torr by using a turbo molecular pump. Also, a transfer robot 190 is installed in the transfer chamber 130 to transfer a wafer on which a lithography process will be performed.

The baking chambers 100 and 110 may be a pre-baking chamber 100 and a post-baking chamber 110. The baking chambers 100 and 110 comprise heating chucks 101 and 111 for heating a loaded wafer, respectively. An adaptor 180 is interposed between the transfer chamber 130 and each of the baking chambers 100 and 110 to provide separated process environments. The pressure in each of the baking chambers 100 and 110 may be held in the range from about 10⁻⁶ torr to 10⁻⁷ torr.

In the present invention, the electron beam lithography system comprises a plurality of lithography chambers 120, 121, and 122 to process a plurality of wafers at the same time. For example, 3 lithograph chambers 120, 121, and 122 are installed as a cluster type. A flexible adaptor 160 and a slot valve 170 are sequentially interposed between the transfer chamber 130 and each of the lithography chambers 120, 121, and 122 to provide separated environments. To accelerate the processing speed, a multicolumn 200 is installed on each of tops of the lithography chambers 120, 121, and 122. Preferably, in each of the lithography chambers 120, 121, and 122, whereas the pressure in an entrance portion into which a wafer is loaded is held in the range from about 10⁻⁶ torr to 10⁻⁷ torr, the pressure in a chamber portion on which the multicolumn 200 is installed is held in the range from about 10⁻¹⁰ torr to 10⁻¹¹ torr.

The loadlock chambers 150 and 151 may be a first loadlock chamber 150 where a wafer stands by to be loaded into a lithography chamber and a second loadlock chamber 151 where a wafer that has undergone a lithography process stays to be loaded out of the lithography system. A wafer cassette 152 is mounted in each of the first and second loadlock chambers 150 and 151. After the wafer cassette 152 has been mounted in each of the first and second loadlock chambers 150 and 151, the loadlock chambers 150 and 151 are shut up and subjected to pumping for evacuation. Also, like the transfer chamber 130, each of the loadlock chambers 150 and 151 is held in a base vacuum environment of about 10⁻⁶ torr to 10⁻⁷ torr. After the entire process is finished, to take out the wafer cassette 152, each of the loadlock chambers 150 and 151 is returned to an atmospheric pressure by injecting an inert gas, such as Ar or N₂ and then opened.

An alignment chamber 140 is installed between the first loadlock chamber 150 and the transfer chamber 130, and a cooling chamber 141 is installed between the second loadlock chamber 151 and the transfer chamber 130. The alignment chamber 140 comprises an aligner 143 for aligning a wafer, and the cooling chamber 141 comprises a cooling plate 141 for cooling a wafer that undergone a thermal process. A slot valve 153 is interposed between the alignment chamber 140 and the first loadlock chamber 150 and between the cooling chamber 141 and the second loadlock chamber 151 to provide separate process environments. However, no partition wall or valve is interposed between the alignment chamber 140 and the transfer chamber 130 and between the cooling chamber 141 and the transfer chamber 130.

FIG. 2 is a sectional view of the electron beam lithography system of FIG. 1, which includes the baking chamber 100, the transfer chamber 130, and the lithography chamber 121.

Referring to FIG. 2, as described above, the lithography chamber 121 is connected to the baking chamber 100 by the transfer chamber 130. The lithography chamber 121 may be connected to the transfer chamber 130 by the slot valve 170 and the flexible adaptor 160.

The transfer chamber 130 and the baking chamber 100 are installed on a general bottom portion 220, and the lithography chamber 121 is installed on an anti-vibrator 210 to protect the lithography chamber 121 from peripheral vibrations. Also, the bottom portion 220 on which the transfer chamber 130 is installed is spaced a predetermined distance apart from the anti-vibrator 210 on which the lithography chamber 121 is installed, to minimize the influence of noise. The anti-vibrator 210 isolates a lithography chamber, for example, an exposure chamber, from vibration noise of the other apparatuses mounted on the general bottom portion 220.

Also, the flexible adaptor 160, which is mounted between the transfer chamber 130 and the lithography chamber 121, isolates the lithography chamber 121 from vibrations generated by the transfer robot 190 and a vacuum pump in the transfer chamber 130. The flexible adaptor 160 may be formed of rubber or stainless steel. However, a gasket formed of stainless steel is preferred as the flexible adaptor 160 in order to prevent outgassing in ultra-high vacuum.

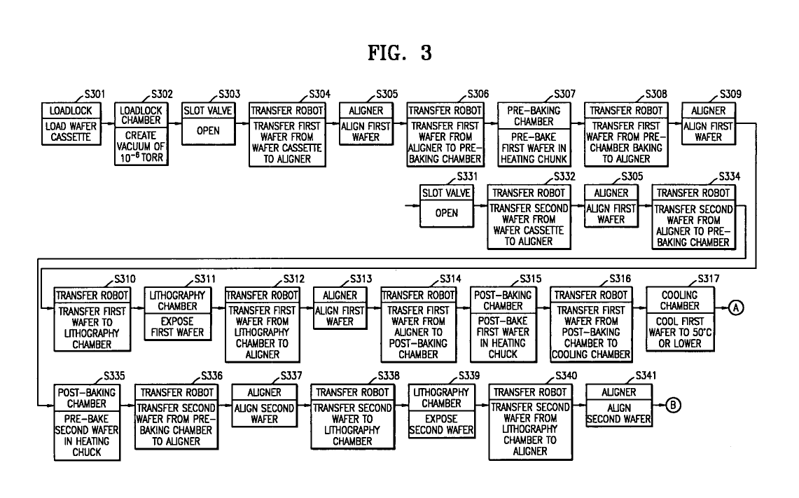

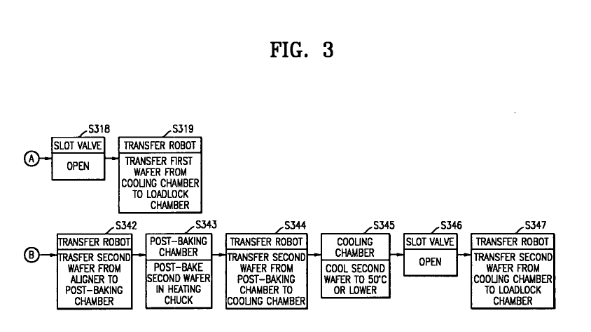

Hereinafter, operations of the electron beam lithography system of the present invention will be described with reference to FIG. 3. FIG. 3 is a block diagram exemplarily illustrates a single system comprising both a pre-baking chamber and a post-baking chamber. For example, if the number of lithography chambers or baking chambers is changed, the following process steps may be changed.

Also, in the present invention, an electron beam lithography process performed on a first wafer 300 and a second wafer 330 at the same time will be described as an example.

Initially, the wafer cassette 152 in which 15 or 25 wafers are mounted is loaded into the first loadlock chamber 150, which is an input loadlock chamber (S301). Next, the first loadlock chamber 150 is held in a vacuum environment of 10⁻⁶ torr or lower (S302). The slot valve 153 between the first loadlock chamber 150 and the alignment chamber 140 is opened (S303), and then the first wafer 300 mounted in the wafer cassette 152 is transferred to the aligner 143 in the alignment chamber 140 (S304) to align the first wafer 300 (S305). The aligned first wafer 300 is transferred to the heating chuck 101 in the pre-baking chamber 100 by the transfer robot 190 (S306) and then heated to a predetermined temperature (S307).

While the first wafer 300 is being pre-baked, the slot valve 153 between the first loadlock chamber 150 and the alignment chamber 140 is opened (S331), and the second wafer 330 mounted in the wafer cassette 152 is transferred to the aligner 143 in the alignment chamber 140 by the transfer robot 190 (S332). Thereafter, the second wafer 330 is aligned in the aligner 143 for a subsequent exposure process (S333).

Meanwhile, after the pre-baking of the first wafer 300 is completed, the first wafer 300 is transferred to the aligner 143 in the alignment chamber 140 (S308), aligned (S309), and then transferred to the lithography chamber 120, 121, or 122 (S310). Thereafter, an exposure process is performed on the first wafer 300 in the lithography chamber 120, 121, or 122 (S311).

While the first wafer 300 is being exposed in the lithography chamber 120, 121, or 122, the transfer robot 190 transfers the second wafer 330 aligned in step 333 to the pre-baking chamber 100 (S334) to pre-bake the second wafer 330 in the heating chuck 101 of the pre-baking chamber 100 (S335). Thereafter, the pre-baked second wafer 330 is transferred to the aligner 143 (S336) and then aligned again (S337). The aligned second wafer 330 is transferred to another lithography chamber 120, 121, or 122 by the transfer robot 190 (S338) and then exposed (S339).

If the exposing of the first wafer 300 is completed, the first wafer 300 is transferred to the aligner 143 (S312) and then aligned again (S313). Next, the transfer robot 190 transfers the first wafer 300 to the heating chuck 111 in the post-baking chamber 110 (S314) to post-bake the first wafer 300 in the heating chuck 111 (S315).

Thereafter, the first wafer 300 is transferred to the cooling chamber 141 by the transfer robot 190 (S316). Also, the second wafer 330 is returned from the lithography chamber 120, 121, or 122 and transferred to the aligner 143 (S340). The second wafer 330 is aligned in the aligner 143 (S341) and then transferred to the post-baking chamber 110 (S342).

Meanwhile, the first wafer 300 is cooled in the cooling chamber 141 to a temperature of 50° C. or lower (S317). The slot valve 153 between the cooling chamber 141 and the loadlock chamber 151 is opened (S318), and then the cooled first wafer 300 is transferred to the wafer cassette 152 in the loadlock chamber 151 (S319).

While the first wafer 300 is being transferred to the loadlock chamber 151, the second wafer 330 is post-baked in the heating chuck 111 of the post-baking chamber 110 (S343) and then transferred to the cooling chamber 141 (S344). Next, like the first wafer 300, the second wafer 330 is cooled in the cooling chamber 141 (S345). Thereafter, the slot valve 153 between the cooling chamber 141 and the loadlock chamber 151 is opened (S346), and the second wafer 330 is transferred through the opened slot valve 153 to the wafer cassette 152 in the loadlock chamber 151 by the transfer robot 190 (S347).

In the electron beam lithography system of the present invention, a plurality of lithography chambers 120, 121, and 122 are installed so as to expose one or more wafers at the same time.

Here, various changes can be made to the algorithm for operating a wafer transfer robot. For example, process chambers may sequentially perform a process depending on the changed algorithm. Alternatively, the amount of time required for the entire process for processing one wafer may be calculated prior to the beginning of the process applied to the processing of a plurality of, for example, 15 or 25, wafers.

As explained thus far, in the electron beam lithography system of the present invention, a plurality of chambers for electron beam lithography are integrated as a cluster. Thus, a plurality of wafers can be exposed in the plurality of chambers at high speed. Also, since a pre-baking process and/or a post-baking process can be carried out in conjunction with a lithography process, the entire process can be performed more efficiently.

The present invention enables mass production and can reduce failures caused by contaminants, such as fine dust, generated before and after lithography processes.

Also, a portion including an element, such as a transfer robot, which generates vibration noise is spaced a predetermined distance apart from a lithography chamber for an exposure process in order to protect the lithography chamber from vibrations. Thus, the lithography resolution improves.

While the present invention has been particularly shown and described with reference to preferred embodiments thereof, it will be understood by those of ordinary skill in the art that various changes in form and details may be made therein without departing from the spirit and scope of the present invention as defined by the following claims.

What is claimed is:

1. An electron beam lithography system comprising:
a transfer chamber;
a plurality of electron beam lithography chambers, each of which is connected to the transfer chamber and includes a multicolumn portion; and
input and output loadlock chambers, each of which is connected to the transfer chamber,
wherein the plurality of electron beam lithography chambers and the input and output loadlock chambers are connected to the transfer chamber, forming a cluster,
and a plurality of wafers are respectively loaded into the plurality of electron beam lithography chambers so as to drive the electron beam lithography chambers at the same time.

2. The system of claim 1, wherein a pre-baking chamber and a post-baking chamber are further connected to the transfer chamber.

3. The system of claim 1, wherein an alignment chamber including an aligner is connected between the transfer chamber and the input loadlock chamber.

4. The system of claim 1, wherein a cooling chamber including a cooling plate is connected between the transfer chamber and the output loadlock chamber.

5. The system of claim 1, wherein a transfer robot for transferring wafers is installed in the transfer chamber.

6. The system of claim 1, wherein a bottom portion on which the transfer chamber is installed is spaced a predetermined distance apart from a bottom portion on which each of the lithography chambers is installed, to cut off noise generated by the transfer chamber.

7. The system of claim 6, wherein the bottom portion on which each of the lithography chambers is installed is an anti-vibrator.

8. The system of claim 1, wherein a flexible adaptor and a slot valve are installed between the transfer chamber and each of the lithography chambers.

9. The system of claim 8, wherein the flexible adaptor is formed of one of rubber and stainless steel.

10. The system of claim 1 or 2, wherein the pressure in each of the transfer chamber, the loadlock chamber, the lithography chambers into which wafers are loaded, the pre-baking chamber, and the post-baking chamber is held in the range from about 10⁻⁶ torr to 10⁻⁷ torr,
and wherein the pressure in the multicolumn portion in each of the lithography chambers is held in the range from about 10⁻¹⁰ torr to 10⁻¹¹ torr.
